(19) United States
(12) Patent Application Publication
(10) Pub. No.: US 2007/0287766 A1
(43) Pub. Date: Dec. 13, 2007

(54) EASILY REMOVABLE UV DEGRADABLE PAINT AND PROCESS FOR APPLYING THE SAME

(75) Inventors: Joseph Kuczynski, Rochester, MN (US); Kevin A. Splittstoesser, Stewartville, MN (US); Timothy J. Tofil, Rochester, MN (US); Paul A. Vermilyea, Rochester, MN (US)

Correspondence Address: CANTOR COLBURN LLP - IBM ROCHESTER DIVISION, 55 GRIFFIN ROAD SOUTH, BLOOMFIELD, CT, 06002, US

(73) Assignee: International Business Machines Corporation, Armonk, NY (US)

(21) Appl. No.: 11/422,994

(22) Filed: Jun. 8, 2006

(51) Int. Cl. B05D 3/04; B05D 3/02; B05D 3/00; D06P 1/52

(52) U.S. Cl. 523/124; 427/372.2; 427/553; 427/348

(57) ABSTRACT

A paint is disclosed herein which comprises a binder having acid-degradable groups, and a photoacid generator that provides photogenerated acid upon exposure to UV light. The binder is water insoluble before exposure to UV light, and binder is water-removable after degradation of the acid degradable groups by the photogenerated acid. A process for applying and removing paint is further disclosed which comprises applying the paint comprising an acid degradable binder and UV sensitive photoacid generator to a surface, and hardening the paint by drying or crosslinking; and removing by exposing the paint to UV light, and directing a high pressure water stream to the exposed paint. The paint is useful as a road paint.

### BACKGROUND OF THE INVENTION

1. Field of the Invention

This invention relates to an ultraviolet (UV) light degradable paint and a process for applying and removing the paint.

2. Description of Background

Paints are useful for numerous applications, including decorative interior and exterior applications, articles, as protective coatings to increase surface durability and protection, and in functional and informational applications. Typically, a useful property for a paint is adhesion to the surface that is painted. However, in some applications that are semi-permanent, for example in paint used on pavement or temporary uses such as in advertising, removability of the paint is also desirable.

Road paints are typically permanent paints that require aggressive methods such as solvents and abrasives for removal. These aggressive removal techniques can damage and scar the pavement (e.g., road) surface. This destructive scarring of the pavement, which may require repair, can be distracting to the motorist, for example by creating an ambiguity as to the location of the actual painted line tinder some circumstances. In addition, current methods of removal of road paints require use of solvents and/or airborne abrasive particles from processes such as sandblasting, scraping, dissolving, or sanding. Such processes require personal protective equipment such as gloves, eye protection, respirators, and the like. An environmentally friendly (e.g., water-borne) paint that is removable using a facile, environmentally friendly process that does not require the use of solvents and/or abrasives, and which does not cause damage to the surface upon removal of the paint, would address these concerns.

What is desired therefore, is a degradable, water-removable paint that, once applied to a surface (road, billboard, wall, etc.), is readily removed from the surface after degradation using a non-damaging method. Such a degradable paint may also be used in other applications where temporary painting, and a non-surface damaging removal method are desired.

### SUMMARY OF THE INVENTION

The shortcomings of the prior art are overcome and additional advantages are provided through the provision of a paint comprising a binder having acid-degradable groups, and a photoacid generator which provides photogenerated acid upon exposure to UV light, wherein the binder is water-insoluble before exposure to UV light, and wherein the binder is water-removable after degradation of the acid degradable groups by the photogenerated acid.

In another embodiment, a process for applying and removing paint comprises applying by contacting a paint comprising an acid degradable binder and UV sensitive photoacid generator with a surface, and hardening the paint by drying or crosslinking; and removing by exposing the paint to UV light, and directing a high pressure water stream to the exposed paint. In a specific embodiment, the paint is a road paint.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution that provides an ultraviolet (UV) light degradable paint useful for applications such as road paint, which allows a facile removal of the paint after hardening. Degradation of the paint by exposure to UV light, followed by removal using high pressure water or a combination of high pressure water and mild mechanical action (e.g., brushing), can remove the paint in a way that mitigates or eliminates any damage to the underlying surface. The paint, and the process for removing the hardened paint after application to a surface, is also environmentally superior compared to other paints and methods of removing hardened paint which use solvents, sand-blasting, other harsh, surface damaging abrasive methods, or the like. The benefits of using the paint, and the process for removing the paint may be seen in the low or nonexistent level of damage to the underlying surface after removal of the paint, and the low or nonexistent particulate and/or solvent emissions during removal.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings wherein:

FIG. 1 illustrates an example of a method for applying a paint to, and removing a paint from a surface.

The detailed description explains the preferred embodiments of the invention, together with advantages and features, by way of example with reference to the drawings.

### DETAILED DESCRIPTION OF THE INVENTION

The problem solved by this invention is a robust paint, useful for roads and other pavement applications. The paint is easy to apply but also easy to remove using a high energy UV light source to degrade the hardened paint for easy, nondestructive, water wash removal at a later date.

Paints generally may be solvent-based or water-based, wherein the paint solidifies and becomes tack-free after application following evaporation of the solvent (including water). Most commercial paints comprise binders, typically polymeric materials that surround and immobilize more diffusing materials such as pigments and other additives dispersed within the paint. The binder provides solvent resistance to the paint and mitigates or prevents the loss of the dispersed species from the painted surface. Binders typically are hardened to form a solvent-resistant film after application. Depending on the type of binder, this hardening may be a result of curing (polymerization), evaporation, or even cooling. Some common cured films are prepared from crosslinkers, such as polyurethane or melamine resins, reacted with acrylic polyester or polyurethane resins, often in the presence of a catalyst that serves to make the curing reaction proceed more quickly or under milder conditions. Some water-borne paints comprise emulsions of solid binders in water, dispersed using a solvent (i.e., a diluent). When the diluent evaporates, the molecules of the binder coalesce to form a solid film. Such emulsion paints are also known as latex paints because the polymer is formed via emulsion polymerization through which the monomers are emulsified in a water-continuous phase. Emulsion polymers themselves are not soluble in water and hence the paint is water resistant after it has dried. In this case, it is not necessary to render the base copolymers water-soluble; they can be cast from the latex and used as a typical water-based paint.

The paint as disclosed herein comprises a binder having acid-degradable groups and a photoacid generator. The binder may be crosslinkable or non-crosslinkable, and can comprise synthetic acrylics, polyurethanes, polyesters, melamines, or latex. In an exemplary embodiment, a binder comprises an acrylic polymer. The binder further comprises acid-degradable functional groups including tertiary alkyl esters, tertiary alkyloxy carbonates, acetals, ketals, or a combination comprising at least one of the foregoing acid labile groups. In an exemplary embodiment, the acid-degradable groups include tert-butyl esters and acetal groups derived from the condensation of a vinyl ether and a carboxylic acid.

Binders for use in the paint applications disclosed herein necessarily include features which allow for a twofold action, referred to herein as solubility switches, which are necessary for a paint that is both castable from and removable using the same solvent (e.g., water). The first solubility switch renders the binder insoluble in solvents after the initial casting of the film, while the second solubility switch renders the binder and/or a paint comprising the binder, removable using an environmentally-friendly solvent (e.g., water). Methods for achieving such a two-solubility switch mechanism in a polymer film can be found analogously in the preparation of positive-tone photoresists for microlithography applications, for example, in the imaging of features for front-end or back end semiconductor manufacturing processes.

In a first method, the first solubility switch may be accomplished using a crosslinking reaction. Yamada et. al. (S. Yamada, D. R. Medeiros, K. Patterson, W. K. Jen, T. Rager, Q. Lin, C. Lenci, J. D. Byers, J. M. Havard, D. Pasini, J. M. J. Fréchet, and C. G. Willson, Proc. SPIE, Adv. in Resist Technology and Processing XV, 1998, Vol. 3333, p. 245; incorporated herein by reference) have demonstrated a method to achieve the two solubility switches in a coated film, by first rendering the film insoluble using a thermally induced crosslinking reaction to form an acid-labile network based on acid-labile crosslinking groups such as acetals. Upon exposure to UV light, acid is generated by a photoacid generator present in the film, wherein the photogenerated acid cleaves the acid-labile crosslink site to generate a water-removable polymer.

Moon et. al. also reported a photoresist system with two solubility switches obtained using crosslinks based on vinyl ether chemistry (S. Moon, K. Kamenosono, S. Kondo, A. Umehara, and T. Yamaoka, Chem. Mater. 1994, Vol. 6, p. 1854; incorporated herein by reference). In this instance, an organic base soluble polymer, such as a cresol novolak or poly(hydroxystyrene), is rendered insoluble in the organic base by a thermally induced crosslinking reaction that proceeds via acetal formation between the acidic hydroxyl group of the polymer and a vinyl ether moiety.

Havard et. al. previously reported evaluation of the crosslinking and de-crosslinking of poly(acrylic acid) with a monomeric divinyl ether additive in methanol (M. Havard, D. Pasini, J. M. J. Fréchet, D. R. Medeiros, K. Patterson, S. Yamada, and C. G. Willson, Proc. SPIE, Adv. in Resist Technology and Processing XV, 1998, Vol. 3333, p. 111; incorporated herein by reference) and modified this design to include a system in which the vinyl ether functionality is a pendant group on the poly(acrylic acid) backbone. Since carboxylic acids add readily to vinyl ethers in aqueous solution, the reactive carboxylic acids were “protected”, i.e., rendered unreactive toward vinyl ethers, by converting them to their corresponding salts. Such a method is illustrated in an exemplary embodiment in Scheme 1.

In Scheme 1, ammonium salt polymers and/or copolymers of Formula (1) are used, which are highly water-soluble and can be cast into high quality films having excellent uniformity and low defectivity. Upon thermal treatment, ammonia is volatilized from the polymer by thermal degradation, and the corresponding free carboxylic acid of Formula (2) is formed. The free acid reacts with a vinyl ether group (Formula (3)) to form an acetal (Formula (4)). This provides an insoluble, crosslinked film comprising the acetal structures of Formula (4). To render the film aqueous soluble, photogenerated acid, generated in the irradiated areas of the film, and water hydrolyze the acetals, thereby “de-crosslinking” the material and converting the polymer into hydroxyethyl by-products of Formula (5), and carboxylic acids of Formula (6), thereby providing a water-removable film with concurrent liberation of acetaldehyde (7), a gaseous by-product.

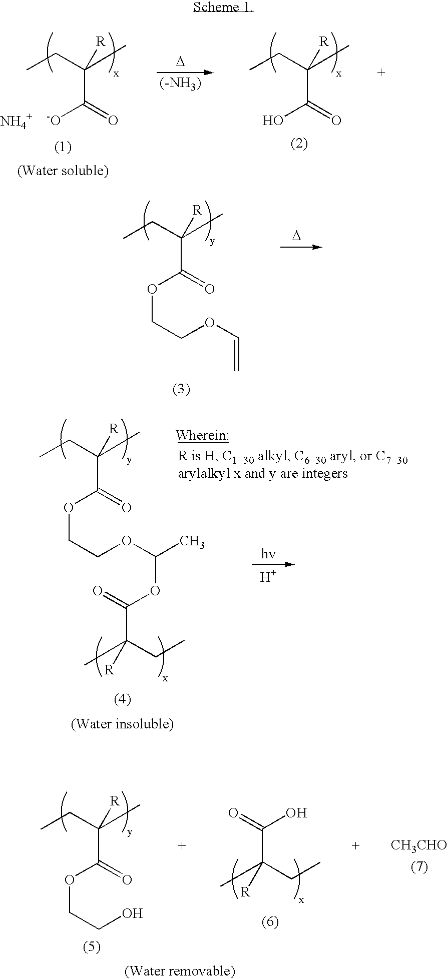

Another method of rendering the binder and/or paint removable after application, and which uses water, is via a polarity switch. Havard et. al. employed an insolubilization mechanism using ammonium salts of carboxylic acids present on the polymer to be rendered insoluble, where the ammonium salts were prepared using volatile amines (e.g., ammonia). Such a method is illustrated in Scheme 2.

In Scheme 2, ammonia is added to a water-insoluble acidic polymer (Formula (8)) to form an ammonium salt of a polymer (Formula (9)) that allows at least partial water miscibility of the polymer. A film can be cast of an aqueous solution of a polymer of Formula (9), wherein upon thermal treatment, the ammonium salt decomposes by thermal degradation to provide the water-insoluble carboxylic acid polymer (Formula (10)) and free ammonia, which is evaporated from the film. Upon UV exposure of the de-ammoniated film, a photoacid generator present in the film provides photogenerated acid, which deblocks an acid-deprotectable group (here for example, a tertiary alkyl ester) in the polymer using photoacid-catalyzed thermolysis (i.e., thermally-driven acid catalyzed decomposition), liberating the deprotected polymer Formula (11)), and by-product (here for example, gaseous isobutylene (12)). The thermolysis to decompose the ester renders UV-exposed areas of the film soluble in an aqueous base developer, and removable using water.

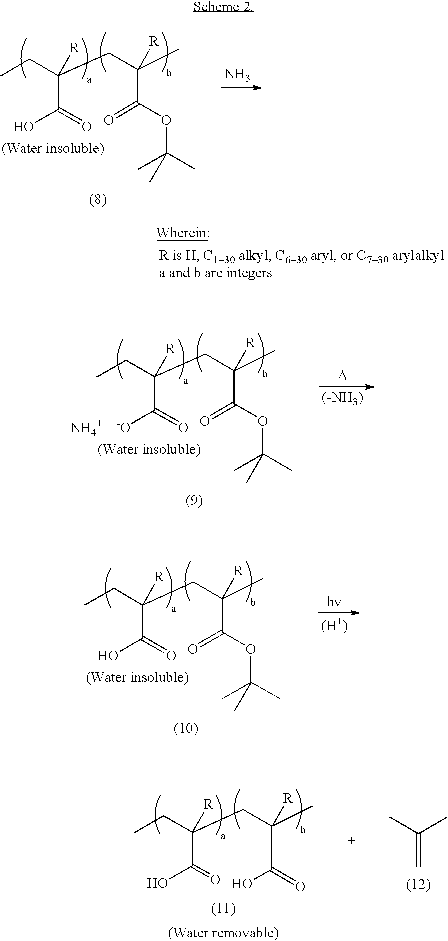

The binder thus comprises at least one polymer having appropriate functionality useful to both provide water solubility and to provide acid deprotectability for the binder. The polymer(s) used in the binder are castable from water. A polymer used in the binder thus comprises, in an embodiment, thermally degradable groups comprising ammonium salts of carboxylic acids. Also in an embodiment, a polymer comprises acid-degradable carboxylate esters including acid labile and/or reactive functionality such as tertiary alkyl esters, vinyl ethers, or a combination comprising one or more of the foregoing functionalities. In an embodiment, the ammonium carboxylate and tertiary alkyl ester functionality are provided in one copolymer. In another embodiment, the ammonium carboxylate and vinyl ether functionality are provided in different polymers. In a specific embodiment, the ammonium carboxylates are derived from the reaction of ammonia with the polymerized residue of acrylic acid and/or methacrylic acid (e.g., Formula (2)). In another specific embodiment, a vinyl ether is derived from the polymerized residue of 2-(meth)acryloxyethyl vinyl ether (e.g., Formula (3), where R is H or CH₃). In another specific embodiment, a tertiary alkyl ester comprises the reaction residue of tert-butyl acrylate (e.g., Formula (8)).

The paint also comprises a photoacid generator. Photoacid generators of use herein are typically ionic aryl substituted sulfonium salts or aryl substituted iodonium salts, or non-ionic diazomethane compounds that may be aryl and/or alkyl substituted. Sulfonium salts and iodonium salts are typically referred to in the art collectively as “onium” salts. Photoacid generators may have aryl group substituents that absorb in the region of the ultraviolet spectrum used to expose the paint. Typically, the photoacid generator has an absorbance corresponding to one or more discrete emission wavelengths present in the ultraviolet emission spectrum of a mercury vapor lamp. Onium photoacid generators can provide different acids as determined by the gegenion (anion) of an onium salt, where the acid strength and diffusivity of the acid are determined by the electronegativity and hydrodynamic radius, respectively, of the gegenion. For the non-ionic photoacid generators, the aryl or alkyl substituents of a diazomethane provide the acid, typically a sulfonic or sulfinic acid, and the acid strength and diffusivity thereof. Typical aryl groups used as substituents in onium salts can include phenyl, naphthyl, substituted versions of these, and the like. Typical gegenions of the onium salts include the halogens (fluoride, chloride, bromide, iodide), tetrafluoborate, hexafluorophosphate, hexafluoroantimonate, trifluorosulfonate, methanesulfonate, ethanesulfonate, cyclohexanesulfonate, cyclohexanesulfonate, camphorsulfonate, benzenesulfonate, 4-toluenesulfonate, 2-trifluoromethylbenzenesulfonate, perfluorobenzenesulfonate, perfluorobutanesulfonate, and the like. Typical substituent groups present on the diazomethane photoacid generators include alkyl, cyclolalkyl, aryl, and polycyclic aryl, and the like. Combinations comprising at least one of the foregoing photoacid generators may also be used.

Appropriate additives, such as pigments (to impart the required color, e.g., white or yellow) are simply mixed into the formulation. Since the aqueous-processable paint of the present disclosure is rendered soluble upon exposure to UV, it is necessary to prevent premature degradation of the paint film. This is accomplished by incorporation of a suitable UV stabilizer such as benzophenone or benzotriazole. Rheology modifiers may be added to optimize flow/spreading of the paint onto the pavement or other substrate.

A solvent, also referred to as a diluent, is typically present in the paint prior to hardening the paint. The diluent serves to adjust the viscosity of the paint, and as such is volatile and does not become part of the paint film. Water is a common diluent, though other solvents including alcohols, other polar solvents such as N-methyl pyrrolidone (“NMP”), polyethers, polyether alcohols, non-polar solvents such as hydrocarbons, and the like, may also be included. Combinations of diluents may be used.

The paint may further comprise a colorant, such as a pigment or dye. Pigments are inorganic or organic, matrix insoluble colorants and are commonly employed in paints. Dyes, which are matrix soluble or liquid colorants, also include both natural and synthetic compounds, and are typically organic or organometallic compounds. Exemplary pigments include, but are not limited to, carbon black, titanium dioxide, zinc oxide, iron oxide, and the like.

Other additives may be included in the paint to modify other properties of the paint, which affect its coating, drying, curing, color-fastness, stability, or other properties. Typical additives include fillers such as visual effects fillers (e.g., reflective fillers, fluorescent tags, etc.), catalysts, thickeners, stabilizers, emulsifiers, texturizers, adhesion promoters, flatteners (also referred to as de-glossing agents), and the like.

The paint may be prepared using any standard method of combining the component polymer(s), photoacid generator, and diluent with any desired pigment, dye, and/or other additive. Combining may be accomplished by mixing, blending, or otherwise forming an intimate blend of these. The components may be combined in any order provided the desired qualities of the paint are preserved. In an embodiment, all components can be combined in advance of use. In another embodiment, one or more components can be combined immediately prior to use and/or combined during dispensing.

Uses of the UV decomposable paint as disclosed herein are also provided. Generally, the UV decomposable paint can be used by applying the paint, preferably as a water-borne solution or emulsion, hardening the paint by air drying, thermally drying, heating, or other methods which are used to remove the solvent and effect a chemical change to harden the paint into a solid, highly solvent and/or water resistant layer. A solvent or water resistant layer as disclosed herein means a layer that is not removable by subsequent treatment with solvent and/or water. The method of use of the paint further provides for its removal by exposure to a light source (e.g., ultraviolet light) to generate an acid via the action of the photoacid generator, and diffusion of the acid through the paint to effect degradation of the paint by degradation of the acid decomposable groups of the binder. Degradation of the paint using light may be accomplished using at least one exposure of the paint to a light source of the desired wavelength(s) and intensity. The paint is then removable using an environmentally friendly solvent. In an embodiment, a desired solvent is water or water-based. In another embodiment, removing the paint comprises directing a high-pressure water stream at the exposed paint. In another embodiment, removing the paint can further comprise brushing the paint free from the surface. In a specific embodiment, the surface is pavement. In another specific embodiment, where the paint is a road paint, brushing is performed using a mechanical street sweeper.

In an embodiment, where the paint is coated sufficiently thinly to allow light to penetrate through to an underlying surface, a single light exposure may be used to degrade the paint. In another embodiment, where the paint is coated sufficiently thickly that the light does not penetrate to the underlying surface, multiple exposures of the paint and/or multiple applications of the high-pressure water stream for removal may be used serially and/or in an alternating method. In an embodiment, the paint may be heated to effect diffusion of the acid in the film to assist in degrading the paint after exposure. In another embodiment, exposing the paint, directing the high-pressure water stream, brushing the paint free from the surface, or a combination comprising at least one of the foregoing, are performed more than once.

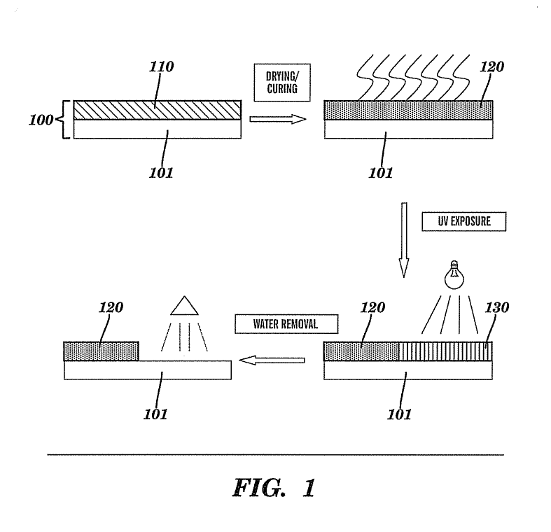

In FIG. 1, a process for applying and removing the paint is shown. In this method, a painted surface 100 is prepared by applying a paint layer 110 to a surface 101. Where the paint uses the first method of a crosslinking reaction, the paint is thermally crosslinked to form a water-insoluble, hardened paint layer 120 by heating or drying the paint 110 to effect a cross-linking reaction. Alternatively, where the paint uses the second method of a polarity switch in which the paint is thermally hardened to form a water insoluble hardened paint layer 120 by decomposing the ammonium carboxylate groups of the binder in paint 110, thereby generating water-insoluble carboxylic acid in the binder and rendering the binder water-insoluble. For either of the first or second methods, the hardened paint is then removed by exposing all or part of the hardened paint layer 120 (here, referred to as exposed paint 130) using UV light to generate acid using the photoacid generator. The exposed paint 130 is degraded by the photogenerated acid to make the binder susceptible to removal using water, and the exposed paint 130 is then removed using water applied as a high-pressure stream.

The capabilities of the above compositions can be implemented in a paint comprising the compositions disclosed hereinabove. For example, one or more aspects of the composition can be included in semi-permanent (i.e., temporary) applications including paint for pavement such as roads, tarmac, sidewalks, parking lots, and the like; and other temporary uses such as advertising on billboards, paint-on advertisements for motor vehicles (buses, cars), walls, banners, and the like. The paint is generally useful for any application for which removability of the paint is desired, and thus the examples herein should be considered as exemplary and not limited thereto.

Compounds are described herein using standard nomenclature. A dash (“-”) that is not between two letters or symbols is used to indicate a point of attachment for a substituent. For example, —CHO is attached through the carbon of the carbonyl (C═O) group. The singular forms “a,” “an,” and “the” include plural referents unless the context clearly dictates otherwise. The endpoints of all ranges reciting the same characteristic or component are independently combinable and inclusive of the recited endpoint. All references are incorporated herein by reference. The terms “first,” “second,” and the like herein do not denote any order, quantity, or importance, but rather are used to distinguish one element from another.

The figures depicted herein describe examples of the invention. There may be many variations to these figures or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A paint comprising:
a binder having acid-degradable groups, and
a photoacid generator that provides photogenerated acid upon exposure to UV light,
wherein the binder is water-insoluble before exposure to UV light, and
wherein the binder is water-removable after degradation of the acid degradable groups by the photogenerated acid.

2. The paint of claim 1 wherein the binder comprises a reaction product of:
a first polymer comprising carboxylic acid groups formed from thermal degradation of the corresponding ammonium salts of the carboxylic acids, and
a second polymer having pendant vinyl ether groups,
wherein the first polymer prior to thermal degradation and the second polymer are each castable from water,
wherein the reaction product comprises acid degradable groups formed from the addition product of the carboxylic acid groups of the first polymer and the pendant vinyl ether groups of the second polymer, and
wherein the reaction product of the first polymer and second polymer is water-insoluble.

3. The paint of claim 1 wherein the binder comprises a thermal degradation product of a polymer having:
thermally degradable groups comprising ammonium salts of carboxylic acid groups, and
acid degradable groups comprising acid degradable derivatives of carboxylic acid groups,
wherein the polymer is castable from water, wherein the polymer is water-insoluble upon thermal degradation of the thermally degradable groups, and wherein the binder is water-removable upon acid degradation of the acid degradable groups.

4. The paint of claim 3 wherein the acid degradable derivatives of the carboxylic acid group are tertiary alkyl esters, tertiary alkyloxy carbonates, acetals, or ketals.

5. The paint of claim 1 wherein the photoacid generator is water-soluble, and wherein the photoacid generator comprises a sulfonium salt, an iodonium salt, a diazomethane compound, or a combination comprising at least one of the foregoing photoacid generators.

6. The paint of claim 1 further comprising a UV stabilizer.

7. The paint of claim 6 further comprising an additive comprising a pigment, a dye, a filler, a catalyst, a thickener, a stabilizer, an emulsifier, a texturizer, and adhesion promoter, a de-glossing agent, a rheology modifier, or a combination comprising at least one of the foregoing additives.

8. The paint of claim 1 wherein the paint is a road paint.

9. A paint comprising:
a binder having acid-degradable groups, wherein the binder comprises either
a reaction product of
a first polymer comprising carboxylic acid groups formed from thermal degradation of the corresponding ammonium salts of the carboxylic acids, and
a second polymer having pendant vinyl ether groups,
wherein the first polymer prior to thermal degradation and the second polymer are each castable from water,
wherein the reaction product comprises acid degradable groups formed from the addition product of the carboxylic acid groups of the first polymer and the pendant vinyl ether groups of the second polymer, and
wherein the reaction product of the first polymer and second polymer is water-insoluble; or
a thermal degradation product of a third polymer having
thermally degradable groups comprising ammonium salts of carboxylic acid groups, and
acid degradable groups comprising acid degradable derivatives of carboxylic acid groups,
wherein the third polymer is castable from water, wherein the third polymer is water-insoluble upon thermal degradation of the thermally degradable groups, and wherein the binder is water-removable upon acid degradation of the acid degradable groups; and
a photoacid generator that provides photogenerated acid upon exposure to UV light,
wherein the binder is water-insoluble before exposure to UV light, and
wherein the binder is water-removable after degradation of the acid degradable groups by the photogenerated acid.

10. The paint of claim 9, wherein the paint is a road paint.

11. A process for applying and removing paint, wherein applying comprises:
contacting a paint comprising an acid degradable binder and UV sensitive photoacid generator with a surface,
hardening the paint by drying or crosslinking, and
wherein removing comprises:
exposing the paint to UV light, and
directing a high-pressure water stream to the exposed paint, or directing a high-pressure water stream to the exposed paint and brushing the paint free from the surface.

12. The process of claim 11, wherein exposing the paint, directing the high pressure water stream, brushing the paint free from the surface, or a combination comprising at least one of the foregoing are performed more than once.

13. The process of claim 11, wherein the paint is a road paint and the surface is pavement.

14. The process of claim 13, wherein brushing is performed using a mechanical street sweeper.
